(19) United States
(12) Patent Application Publication
(10) Pub. No.: US 2009/0076215 A1
(43) Pub. Date: Mar. 19, 2009

(54) Polypropylene grids manufactured with a beta nucleation additive, the method of manufacture and uses thereof

(75) Inventors: William Shelton, Lithonia, GA (US); John Pocher, Austin, TX (US)

Correspondence Address: JACOBSON HOLMAN PLLC, 400 SEVENTH STREET N.W., SUITE 600, WASHINGTON, DC, 20004, US

(73) Assignee: Tensar Corporation

(21) Appl. No.: 12/078,806

(22) Filed: Apr. 4, 2008

Related U.S. Application Data
(63) Continuation of application No. 11/131,184, filed on May 18, 2005, now abandoned.
(60) Provisional application No. 60/582,539, filed on Jun. 25, 2004.

(51) Int. Cl. C08L 23/12; C08F 10/06; C08F 6/00

(52) U.S. Cl. 524/576; 526/348.1; 526/351; 528/502 B

(57) ABSTRACT

Integral polymer grids, such as geogrids, are made by stretching and orienting a polypropylene starting sheet material having a defined pattern of holes or depressions in which the polypropylene is at least 50%, and preferably up to about 80%, beta crystals caused by adding a beta nucleating agent to the polypropylene, preferably in concentrations between about 10 ppm to about 100 ppm. Such beta nucleated polypropylene grids exhibit increased yield and break tensile strengths, increased 2% and 5% tensile strengths, increased modulus characteristics, increased torsional stiffness, increased impact strength, and increased grid junction strength. Methods for manufacturing the beta nucleated polypropylene mesh grids are disclosed, along with applications for stabilizing particulate material in civil engineering structures, and the like.

This application claims the benefit of priority to U.S. provisional patent application Serial No. 60/582,539, filed Jun. 25, 2004.

### BACKGROUND OF INVENTION

1. Field of Invention

The present invention relates generally to integral polymer geogrids and other oriented grids used for structural or construction reinforcement purposes. More particularly, the present invention relates to such integral polymer grids made from homopolymer and copolymer polypropylene in which a beta nucleation agent has been added to enhance the desired physical characteristics of the grid.

This invention also relates to the method for the production of such beta nucleated polypropylene grids so as to improve production rates and parameters for the orientation of the polymer grids. Lastly, the present invention relates to the use of such integral polymer geogrids for soil reinforcement and methods of such reinforcement.

For the purpose of this invention, the term “integral polypropylene grids” is intended to include integral polypropylene geogrids and other integral polypropylene grid structures made by orientating (stretching) starting materials in the form of sheets or the like that have a mean thickness of at least 0.75 mm, and preferably at least 1.5 mm or more.

2. Description of the Related Art

Plastic material integral grid structures having mesh openings defined by a generally rectangular grid of substantially parallel, orientated strands and junctions therebetween, such as geogrids, have been manufactured for over 25 years. Such grids are manufactured by extruding an integrally cast sheet which is subjected to a defined pattern of holes or depressions followed by the controlled uniaxial and biaxial orientation of the holes or depressions to form into mesh openings. These integral oriented polymer grid structures can be used for retaining or stabilizing particulate material of any suitable form, such as soil, earth, sand, clay, gravel, etc. and in any suitable location, such as on the side of a road or other cutting or embankment, beneath a road surface, runway surface, etc.

The manufacture and use of such geogrid and other integral polymer grid structures can be accomplished by well known techniques. As described in detail in U.S. Pat. No. 4,374,798 to Mercer et al., No. 5,419,659 to Mercer et al., No. 4,590,029 to Mercer et al., No. 4,743,486 to Mercer and Martin, and No. 4,756,946 to Mercer, a starting polymer sheet material is first extruded and then punched to form the requisite defined pattern of holes or depressions. In U.S. Pat. Nos. 3,252,181, 3,317,951, 3,496,965, 4,470,942, 4,808,358 and 5,053,264, the starting material with the requisite pattern of holes or depressions is formed in conjunction with the polymer extrusion. It is intended that the present invention be applicable to all integral polypropylene grids regardless of the method of forming the starting material or orienting the starting material into the geogrid or grid structure. The subject matter of the foregoing patents is expressly incorporated into this specification by reference as if the patents were set forth herein in their entireties. These patents are cited as illustrative, and are not considered to be inclusive, or to exclude other techniques known in the art for the production of integral polymer grid materials.

The polymeric materials used in the production of such integral grids heretofore have been high molecular weight homopolymer and copolymer polypropylene and high density, high molecular weight polyethylene copolymer and with the addition of varying amounts of additives, such as carbon black, ultra-violet light inhibitors, etc. For the use and applications of integral polymer geogrids and other integral polymer grid structures, such as described in the above-referenced U.S. Pat. No. 5,419,659 to Mercer et al., it would be desirable and advantageous, and significantly more economically viable, if it were possible to enhance the break and yield tensile strengths, the torsional and flexural stiffness, the modulus characteristics, and the impact strength of the oriented grids. It would also be desirable and more economic if the speed of orientation, whether uniaxial or biaxial, from the integrally cast and perforated starting material could be increased significantly above the orientation speeds currently being practiced.

### SUMMARY OF THE INVENTION

The most common crystal form of polypropylene is the alpha crystal which melts at approximately 160° C. for typical Zeigler-Natta polymerized homopolymer or copolymer polypropylene. A less common form, known as the beta or hexagonal crystal form, generally comprises less than 5% of the polypropylene crystals. The beta crystals have a melting point that is typically 12-15° C. below that of the alpha form. It is known that the beta phase of an isotactic polypropylene can improve toughness and impact strengths. Finally, a beta nucleator activated at the appropriate processing temperature during cast sheet extrusion, sharply raises the percentage of beta crystals.

There are known different beta initiators for polypropylene. The most common types known are red dye pigments (e.g. quinacridones). Others are considered non-pigmenting such as a new class developed as a solid white powder by New Japan Chemical designated NJ Star NU-100, which is introduced into polypropylene during processing or compounding. Previously, beta nucleants have been added for processing biaxially oriented polypropylene film (BOPP). This work with BOPP film is disclosed in U.S. Pat. Nos. 5,310,584, 5,594,070, 5,317,035, 5,236,963, 5,176,953, and 4,975,469.

It has now been surprisingly found that compounding polypropylene with a beta nucleating agent which converts the alpha polypropylene to the beta form, preferably to a level up to 80%, for the polypropylene in the starting sheet material, will result in a final oriented grid, stretched either uniaxially or biaxially, which has significantly higher yield and break tensile strengths, torsional and flexural stiffness, modulus characteristics, and impact resistance, over substantially identical oriented grids made from polypropylene without a beta nucleating agent added. The increased strengths and stiffness are beyond those that have been obtained to date in the practice of the referenced patents at all the indicated starting sheet thicknesses. Another way to view the present invention is that the heretofore obtainable finished product yield and break tensile strengths, as well as the 2% and 5% tensile strengths, modulus, torsional and flexural stiffness and impact characteristics, at all previous starting sheet thicknesses as practiced in the referenced patents, can now be obtained with starting sheet thicknesses and masses that are 5%-25% less than those prior to the practice of the present invention.

It has further been surprisingly found that the speed of orientation of the beta-enhanced polypropylene starting material can be significantly increased and carried out at the same and lower temperatures over standard polypropylene starting materials, thus significantly reducing the production costs for manufacturing the final grids. This increase in speed has been demonstrated to be at least 1.5 times as high as currently practiced, and up to. three, times as high, or more. Finally, the oriented beta-enhanced polypropylene grids have a significantly lighter weight (lbs/sq.ft.) than conventional oriented polypropylene grids of the same strength and performance characteristics, thus saving on material and shipping costs.

It is believed that conversion of the alpha polypropylene crystals by the beta nucleating agent to as little as 20%-30% of the beta crystalline form in the final starting sheet material can cause the resultant oriented grid, after stretching uniaxially or biaxially, to exhibit the improved property characteristics and orienting enhancements described herein. However, higher conversion is clearly desirable so that the full benefits of the polypropylene beta crystalline structure result. Hence, the beta nucleating conversion should preferably result in a starting sheet material having up to 80%, or more, polypropylene in the beta crystalline form.

Accordingly, it is an object of the present invention to produce an integral geogrid or other grid structure from a beta nucleated polypropylene starting material according to known process methods, such as those described in the aforementioned U.S. Pat. Nos. 4,374,798, 5,419,659, 4,590,029, 4,743,486, 4,756,946, 3,252,181, 3,317,951, 3,496,965, 4,470,942, 4,808,358 and 5,053,264, as well as many other patents.

It is a further object of the present invention to produce a beta nucleated polypropylene geogrid or other grid structure manufactured in accordance with known process methods which will exhibit increased yield and break tensile strengths, increased 2% and 5% tensile strengths, increased modulus characteristics, increased torsional and flexural stiffness, increased impact strength and increased grid junction strengths as measured by current test methods, ASTM D6637 and the U.S. Army Corps of Engineers Methodology for the torsional stiffness.

Another object of the present invention is to provide a polypropylene starting material having at least 20%-30% of the polypropylene crystals in the beta form, preferably up to about 80%, which substantially increases the speed of orienting the perforated starting sheet at all defined starting sheet thicknesses, beyond those obtainable with presently used polypropylene starting materials.

Yet another object of the present invention is to produce an integral polypropylene geogrid or other grid structure by incorporating an additive that modifies the crystalline structure of the polypropylene cast starting sheet such that a broader window of processing in the form of lower orientation temperatures is realized, along with resultant increased yield and break tensile strengths, increased 2% and 5% tensile strengths, increased modulus characteristics, and increased torsional and flexural stiffness at all defined cast sheet thicknesses, over that achievable using identical polypropylene polymers without the additive.

### BRIEF DESCRIPTION OF THE DRAWINGS

FIG. 1 is a table setting forth key properties for four finished integral geogrid products comparing a standard BX1200 polypropylene geogrid manufactured and sold by The Tensar Corporation, Inc. (Georgia) (hereinafter “Tensar”), the assignee of the instant application, at its manufacturing facilities in Morrow, Ga., with three test polypropylene integral geogrids manufactured by Tensar in the same way but containing a polypropylene beta nucleating agent in the starting sheet, but having different starting sheet thicknesses.

FIG. 2 is a continuation of Table 1 setting forth further properties of the finished geogrids listed in FIG. 1.

FIG. 3 is a table which sets forth key properties for four finished integral geogrid products comparing Tensar's standard BX1200 polypropylene geogrid, also manufactured at Tensar's manufacturing facilities in Morrow, Ga., with three test polypropylene integral geogrids manufactured by Tensar in the same way but containing a second polypropylene beta nucleating agent in the starting sheet, and having different starting sheet thicknesses.

FIG. 4 is a continuation of Table 3 setting forth further properties of the finished geogrids listed in FIG. 3.

### DETAILED DESCRIPTION OF THE INVENTION

The present invention contemplates the addition of one or more beta nucleation additives to the polypropylene batch for the extrusion of starting cast sheet. After or during extrusion, the beta nucleated sheet is perforated or depressed to form holes or indentations, and then either uniaxially or biaxially stretched in accordance with known methods and practices, preferably those described in the above-referenced U.S. Pat. Nos. 4,374,798, 5,419,659, 4,590,029, 4,743,486, and 4,756,946.

For the present invention, the more common red quinacridone dye nucleating agent is preferably used. The quinacridone dye is often effective at very low levels in the parts per million (ppm) range, and is generally formulated as a polymer concentrate having 2000 ppm, more or less, of the quinacridone dye in a polypropylene carrier.

One supplier of red quinacridone dye nucleating concentrate is Standridge Color Corporation (“Standridge”), of Social Circle, Ga. The Standridge beta nucleating concentrate is a concentrated pellet product that contains approximately 2000 ppm of the beta nucleating red quinacridone dye in a polypropylene homopolymer carrier resin. Another supplier of a red quinacridone dye nucleating concentrate is Mayzo, Inc (“Mayzo”) of Norcross, Ga. A Mayzo beta nucleating concentrate designated BNX BETA PP is a concentrated pellet product that is believed to contain 450 ppm, more or less, of the beta nucleating red quinacridone dye in a polypropylene homopolymer carrier resin that has a melt flow index of 4.0 grams/10 mins, more or less. Other manufacturers or suppliers may also provide an equivalent or similar beta nucleating agent when added to polypropylene resin. Another such product, for example, is designated NJ Star NU-100, and manufactured by a company named Japan Chemical Company. This beta nucleating agent is a solid white powder, and is introduced into polypropylene during processing or compounding.

The beta nucleating agent in concentrated pellet form is preferably blended with the polypropylene used to manufacture the grid prior to or during the extrusion of the starting cast sheet material. The beta nucleating concentrate is mixed with the polypropylene at levels of about 0.5% up to about 5% or more. With a concentrate containing 2000 ppm of the beta nucleating reagent, the preferred concentration of the beta nucleating reagent in the extruded or cast polypropylene starting sheet is about 10 ppm, and perhaps less, to about 100 ppm. The addition of the beta nucleating concentrate converts the normally alpha crystalline structure, with only about 5% beta crystals, or less, to a cast sheet after extrusion having up to 80% of the polypropylene in the beta crystalline form. It is this beta crystalline formation in the extruded or cast starting sheet material that, once uniaxially or biaxially oriented into a finished grid mesh, results in the higher yield and break tensile strengths, 2% and 5% tensile strengths, modulus characteristics, torsional and flexural stiffness, and impact strength. It is believed that the conversion of the alpha polypropylene crystals should produce at least fifty percent (50%) beta crystals, and preferably about 75% to about 80%, or more, in the polypropylene starting sheet in order to achieve the surprisingly improved results described herein.

The starting sheet thickness ranges and the extent and method of orientation are preferably the same as that disclosed in U.S. Pat. No. 5,419,659, for both uniaxial and biaxial orientation. The starting material, when biaxially stretched in accordance with one embodiment of the present invention, produces junctions between the strands which are not flat, but exhibit some thinning. The junctions have a minimum thickness which is not less than 75% of the thickness of the mid-point of any of the strands passing into the junction. Each junction is a solid junction and has a central zone which is thicker than the orientated lateral zones around the central zone.

Following the formation of the polypropylene starting material with the beta nucleator concentrate additive, and the subsequent uniaxial or biaxial orientation, the ratio of the center portion of any strand entering the junction and the thickest part of the resultant junction node is preferably about 90% or less, although this ratio could be larger or smaller than 90%, and not be outside the scope of the invention. This ratio on a conventional polypropylene biaxial grid (without a beta nucleating additive), made by Tensar, is approximately 78% or less. A beta nucleated starting sheet, when biaxially stretched, can orient more through the junction zone than does that of a non-beta nucleated sheet. It is believed that this increased junction orientation is one of the contributing factors to the increased tensile strengths and torsional or rotational stiffness of the beta nucleated grids. Conversely, a beta nucleated starting sheet, when biaxially stretched, can also orient more in the strand zones and less through the junction zone than that of a non-beta nucleated sheet, still providing increased tensile strengths and flexural stiffness of the beta nucleated grids.

With the addition of the beta nucleating agent in the starting sheet, and by following the standard extrusion temperature profile and extrusion throughput rates as practiced by Tensar for the range of uniaxial and biaxial polypropylene products offered for sale by Tensar, the starting cast sheet in accordance with the present invention should contain a high level of the beta form of crystallinity, at least 50%, and preferably from about 75% to about 80%, or more. It is believed that this unique crystal morphology changes the processing characteristics of the starting sheet during the subsequent uniaxial and biaxial orientation steps. These changes result in the sheet having a broader processing window, and an improved ability to draw the sheet at lower temperatures and hig her speeds.

Initial trial work in accordance with the present invention was carried out by Tensar using a beta crystalline polypropylene coded B022SP, a 2.0 melt flow homopolymer polypropylene obtained from Sunoco Polymers of 550 Technology Drive, Pittsburgh, Pa. 15219. Standard flat “dog-bone”-shaped samples, having a thickness of about 0.060 inches, were prepared of the Sunoco beta crystalline polypropylene and conventional polypropylene, and the samples stretched in a lab stretcher in accordance with standard stretching protocols used by The Tensar Corporation. The samples were stretched at 4:1 and 5:1 ratios, all at 230° F. The middle six inches of oriented material (there being unoriented material in or near the clamped ends of each specimen), was tensile tested at an elongation rate of 5 mm./min. The 4:1 ratios showed an increase of 17% in tensile modulus, and an increase of 33% in ultimate tensile load for the Sunoco beta crystalline polypropylene samples over the conventional polypropylene samples. The 5:1 ratios showed an increase of 12% in tensile modulus, and 30% in ultimate tensile load.

Subsequent sheet plaques were prepared by Sunoco of its beta crystalline polypropylene and conventional polypropylene. The plaques having a thickness of about 0.060 inches were perforated and uniaxially oriented by Tensar on a laboratory stretcher in accordance with Tensar's standard testing protocol for stretching uniaxially oriented grid structures. The oriented beta nucleated samples showed a 77% increase in tensile modulus, and a 19%-33% increase in ultimate tensile strength over the oriented non-beta nucleated samples.

Later tests have demonstrated that a beta crystalline starting sheet made in accordance with the present invention orients more easily and requires less initiation stress to start the orientation than does a conventional polypropylene starting sheet without a beta nucleating additive. It is believed that these characteristics result in the higher stretching speeds. By way of example, Tensar demonstrated during trials, that with the addition of about 2.5% of the Mayzo concentrate (which is believed to contain 450± ppm red quinacridone dye beta nucleant) to the polypropylene resin, the resultant biaxial polypropylene grid can be oriented at two times the speed of the identical starting sheet without the beta nucleant addition. The identical process extrusion and stretching conditions were used for both starting sheets in these trials. Subsequent research indicates that this stretching speed could be increased to three times, or even higher, with the beta nucleant addition. The impact on improved productivity and lower production costs achieved by this invention should, therefore, be obvious.

A further benefit of the beta nucleation is a reduction in the basis weight of the final grid product without a loss in physical test properties relative to that of the current commercial products as produced by Tensar. It is currently believed that this weight reduction is achieved by the beta crystalline phase which causes microvoids or minute pores to form in the starting sheet when the sheet is oriented under the controlled conditions as practiced currently by Tensar for the family of uniaxial and biaxial products. These microvoids presumably lead to a density reduction as well as contributing to the increased orientation speeds via reduced initiation stress required for orientation.

### EXAMPLE 1

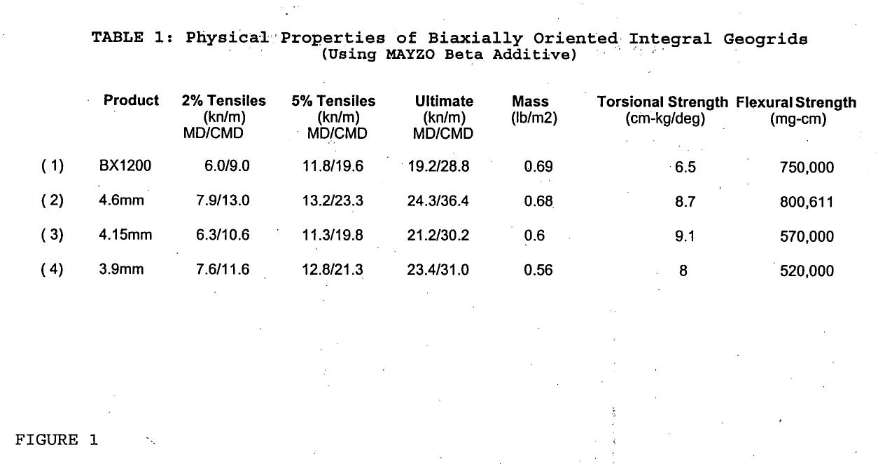

In a first example, a standard commercial Tensar polypropylene product, designated as BX1200, was used for comparison. Tensar BX1200 is a biaxially stretched and oriented integral geogrid produced from high molecular weight, fractional melt index polypropylene from a starting cast sheet having a thickness of 4.6 mm. Carbon black at approximately 1% is added to the final product for ultra-violet ray protection. The standard minimum average roll values (MARV) for the key properties of the Tensar BX1200 finished grid are shown in line (1) of Table 1 in FIG. 1. For comparison, starting sheets having thicknesses of 4.60 mm, 4.15 mm, and 3.90 mm were prepared with an addition of about 2.68% of Mayzo beta nucleant BNX BETA PP concentrate added to the polypropylene. It is believed that this addition resulted in a polypropylene having a red quinacridone dye beta nucleant concentration of about 12 ppm. The beta nucleated starting sheets were prepared and stretched in accordance with the same process conditions as the commercial Tensar BX1200 product, including the about 1% carbon black addition. The same material properties were measured and are listed in lines (2), (3) and (4) of Table 1 in FIG. 1.

As shown in Table 1 in FIG. 1, each cast sheet thickness with the beta nucleant added, exceeded all of the key desired properties of the standard Tensar BX1200. Of special significance is that the 3.90 mm thick cast starting sheet with the beta nucleant added, line (4) of Table 1, which is almost 18% thinner than the standard Tensar BX1200 starting sheet, produced a grid which exceeded all of the property requirements for the standard Tensar BX1200 grid. Without the beta nucleant addition, a 3.90 mm thick polypropylene starting sheet would have produced a grid with properties far short of these properties. These results confirm that a minimum of 10%, more or less, weight (thickness) reduction in the starting sheet material with the addition of a beta nucleant, will achieve the same or better grid properties following orientation than a sheet without addition of the beta nucleant.

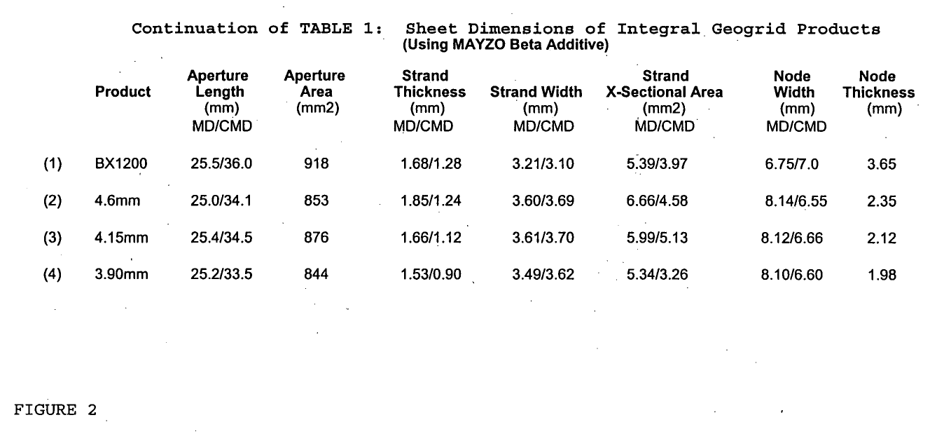

Sheet dimensions of the products of Example 1 are shown in the continuation of Table 1 in FIG. 2. Measurements of aperture length, aperture area, strand thickness and width, strand cross-sectional area, node width and thickness of the BX1200 finished grid are there compared to the three beta nucleated test sheets having thicknesses of 4.60 mm, 4.15 mm, and 3.90 mm. The results show that the addition of the beta nucleant caused the grid aperture lengths and open areas to be smaller, while resulting in wider strands and nodes and comparable greater strand cross-sectional area. In each beta nucleated test grid, the junction (or node) tensile strength was 95%, or higher, of the tensile strength of the strands.

### EXAMPLE 2

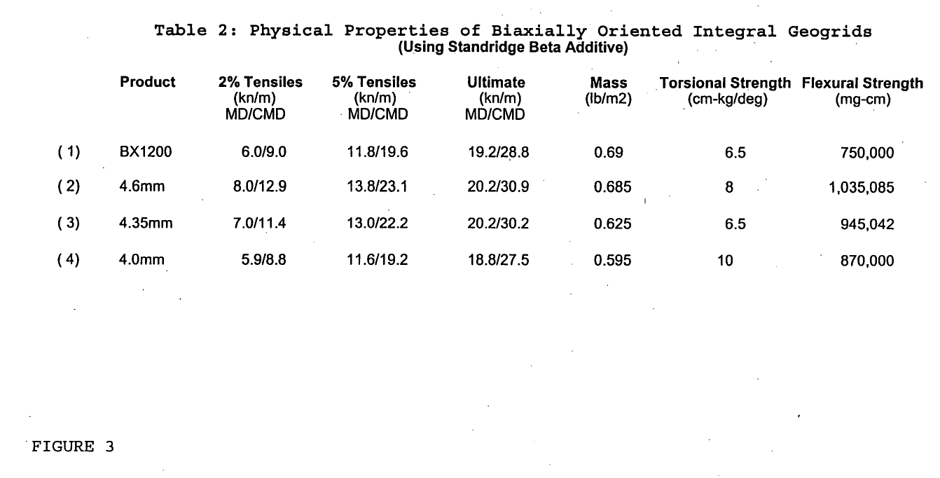

As in the first example, the standard commercial Tensar BX1200 polypropylene biaxial geogrid was used for comparison. The standard minimum average roll values (MARV) for the key properties of the Tensar BX1200 finished grid are also shown in line (1) of Table 2 in FIG. 3. For comparison, three test starting sheets having thicknesses of 4.60 mm, 4.35mm, and 4.00 mm, respectively, were prepared with an addition of either 1.5% or 1.65% of the Standridge beta nucleant polypropylene concentrate added to the polypropylene starting sheets. The Standridge beta nucleant polypropylene concentrate used in this example was a quinacridone red dye concentrate with a polypropylene carrier resin having approximately 2000 ppm of the red dye beta nucleant. Hence, the concentration of the beta nucleant in the 4.60 mm and 4.35 mm test samples, lines (2) and (3) of Table 2 in FIG. 2 was approximately 30 ppm (a 1.5% addition), and the concentration in the 4.0 mm was about 33 ppm (a 1.65% addition). The beta nucleated starting sheets were prepared and stretched in accordance with the same process conditions as the commercial Tensar BX1200 biaxial geogrid. The same material properties were measured and are shown in lines (2), (3) and (4) of Table 2 in FIG. 3.

Table 2 of FIG. 3 shows that the cast sheet thicknesses of 4.6 mm and 4.35 mm with the Standridge beta nucleant added, lines (2) and (3), also exceeded all of the key desired properties of the standard Tensar BX1200 biaxial geogrid. The 4.0 mm sheet, line (4), had properties which were only slightly less than the BX1200 control grid in most categories, and was still superior in torsional and flexural strength.

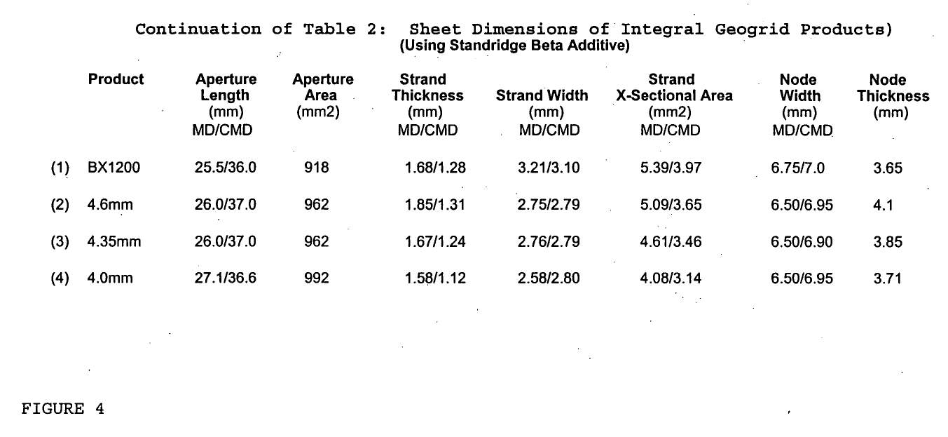

Sheet dimensions of the products of Example 2 are shown in the continuation of Table 2 in FIG. 4. The results show that the addition of the Standridge beta nucleant allowed the aperture lengths and areas of the grid to be larger than the BX1200 control grid. The resulting strand widths of the beta nucleant treated polypropylene grids were narrower with narrower node widths but having larger node thicknesses. In each beta nucleated test grid, the junction (or node) tensile strength was 95%, or higher, of the tensile strength of the strands.

With the Standridge beta nucleant, the node mass is not pulled into the MD and CMD strands as much as with the Mayzo nucleant, resulting in thicker nodes, narrower strands, higher flexural rigidity, but lower torsional rigidity for the Standridge nucleated geogrid product, even though comfortably within current specifications for the BX1200 geogrid. Also, the aperture area is larger with the Standridge additive.

It is noted that when using the nucleating agents, the torsional stiffness increased even at the thinnest starting sheet. Application research strongly indicates that torsional resistance effectively captures the complex interaction of initial tensile modulus, stiffness, confinement, and stability when used in soil stabilization. Hence, geogrids and other grid structures made in accordance with the present invention, having this increased torsional stiffness resulting from the beta nucleant additive, should perform even better and should be more economically viable when used in soil stabilization applications.

What is claimed is:

1. An integral polymer grid which comprises an oriented polypropylene grid, either uniaxially or biaxially stretched, said polypropylene grid having a minimum of 20% polypropylene in the beta crystalline form

2. The integral polymer grid of claim 1, wherein said polypropylene grid has a minimum of 50% polypropylene in the beta crystalline form.

3. The integral polymer grid of claim 1, wherein said polypropylene grid has a concentration of a beta nucleant of about 10 ppm to about 100 ppm of said grid.

4. The integral polymer grid of claim 1 wherein said polypropylene grid has at least 80% polypropylene in the beta crystalline form.

5. A starting material for making a uniaxially or biaxially oriented grid which comprises a polypropylene sheet having perforations or indentations to form openings when said sheet is stretched and having a minimum of 20% polypropylene in the beta crystalline form

6. The polypropylene sheet of claim 5 having a minimum of 50% polypropylene in the beta crystalline form.

7. The polypropylene sheet of claim 5 having a concentration of beta nucleant of about 10 ppm to about 100 ppm.

8. The polypropylene sheet of claim 5 having at least 80% polypropylene in the beta crystalline form.

9. A method of making an integral polypropylene grid which comprises adding a beta nucleating agent to polypropylene and forming or casting said beta nucleated polypropylene into a sheet-like starting material having a defined pattern of holes or depressions, and uniaxially or biaxially orienting said starting material under controlled conditions to form said holes or depressions into grid openings.

10. The method of claim 9, wherein said beta nucleating agent is a red quinacridone dye.

11. The method of claim 9, wherein said beta nucleating agent is present at a concentration of about 10 ppm to about 100 ppm.

12. The method of claim 9, wherein the beta nucleating agent is added in a concentrated form having about 450 ppm to about 2000 ppm of the beta nucleating agent in a polypropylene resin mixture.

13. The integral polymer grid of claim 1 wherein said polypropylene grid has increased tensile, torsional and flexural strength when compared to the same polypropylene grid manufactured without addition of a beta nucleating agent.

14. A reinforced civil engineering structure comprising a mass of particulate material and a reinforcing oriented polypropylene grid therefor, either uniaxially or biaxially stretched, which has a minimum of 20%-30% polypropylene crystals, and preferably up to about 80%, in the beta form.

15. A method of constructing a civil engineering structure which comprises providing a mass of particulate material and reinforcing said material with an oriented polypropylene grid, either uniaxially or biaxially stretched, which has a minimum of 20%-30% polypropylene in beta crystalline form, and preferably up to about 80%, in beta crystalline form.

16. The integral polymer grid made by the method of claim 11, wherein the extruded sheet can be run at line speeds that are at least 5% faster than the line speeds for an extruded polypropylene sheet with no added beta nucleant and the same starting thickness.

17. The integral polymer grid made by the method of claim 11, wherein the grid has thickness in the node junction region between the machine direction and transverse direction strands that is at least 10% less than that of a biaxially oriented web made from an extruded sheet with no added beta nucleant and the same starting sheet thickness.

18. The integral polymer grid made by the method of claim 11, wherein the grid has a thickness in the node junction region between the machine direction strands and transverse direction strands that is at least 5% more than that of a biaxially oriented web made from an extruded sheet with no added beta nucleant and the same starting sheet thickness.

19. The integral polymer grid made by the method of claim 11, wherein the grid has a tensile strength measured at 2% elongation in the machine direction, that is at least 10% higher than that of a biaxially oriented web made from an extruded polypropylene sheet with no added beta nucleant and the same starting thickness.

20. The integral polymer grid made by the method of claim 11, wherein the grid has a tensile strength measured at 5% elongation in the machine direction, that is at least 10% higher than that of a biaxially oriented web made from an extruded polypropylene sheet with no added beta nucleant and the same starting thickness.

21. The integral polymer grid made by the method of claim 11, wherein the grid has a increased node width, narrower strand width, increased flexural rigidity and decreased torsional. rigidity than that of a biaxially oriented web made from an extruded polypropylene sheet with no added beta nucleant and the same starting thickness.

22. An extruded polypropylene sheet for manufacturing an integral geogrid structure comprising a nucleating agent in a concentration of about 10 ppm to about 100 ppm of total polypropylene content.

23. The sheet of claim 21, further comprising additives selected from the group consisting of stabilizers, pigments, and processing agents which do not nucleate the alpha crystal form of polypropylene.

24. A method of manufacture of a polypropylene sheet containing a nucleating agent which comprises:
(a) adding a nucleating agent to a polypropylene batch for a final concentration of nucleating agent of between about 10 ppm to about 100 ppm; and
(b) extruding a starting sheet.

25. The method of claim 23 further comprising uniaxially orienting the polypropylene in the sheet.

26. The method of claim 24, wherein the sheet is biaxially oriented.

27. The method of claim 9, wherein the step of adding a beta nucleating agent to the polypropylene is carried out by adding a beta nucleating concentrate to non-nucleated polypropylene, said concentrate containing from about 450 ppm to about 2000 ppm of said beta nucleating agent.

28. A concentrate for use in manufacturing an oriented polypropylene grid which comprises polypropylene and a beta nucleating agent, said nucleating agent being present in a concentration from about 450 ppm to about 2000 ppm in the concentrate.
